(19) United States
(12) Patent Application Publication
(10) Pub. No.: US 2003/0138215 A1
(43) Pub. Date: Jul. 24, 2003

(54) Wavelength division multiplexer

(76) Inventors: Mingbao Zhou, Shenzhen (CN); River Yang, Shenzhen (CN); Qing Liu, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/172,232

(22) Filed: Jun. 13, 2002

(30) Foreign Application Priority Data
Jan. 18, 2002 (TW) 91200441

(51) Int. Cl. G02B 6/26; G02B 6/32; G02B 6/38

(52) U.S. Cl. 385/47; 385/33; 385/31; 385/61; 385/74

(57) ABSTRACT

A wavelength division multiplexer according to the present invention includes a first collimator (10), a second collimator (20), a filter (30), a holder (40) and an outer sleeve (50). The first collimator has a first ferrule (12) within which input and reflective optical fibers (112), (111) are secured. The first ferrule has an oblique face (122) that is mounted opposite an oblique face (132) of a first molded lens (13). A first inner tube (14) partially encloses the first ferrule, and a first outer tube (15) then encloses the first inner tube. The holder has a seat (44) receiving an aspherical face (131) of the first molded lens therein. The filter is fixed onto a free end of the holder. The second collimator has a structure similar to that of the first collimator. The two collimators are aligned with each other and retained in the outer sleeve by welding.

### BACKGROUND OF THE INVENTION

1. Field of the Invention

The present invention relates to Wavelength Division Multiplexer (WDM), and more particularly to a WDM which has a low manufacturing cost and which is high precision.

2. Description of the Prior Art

WDM systems are widely deployed in modem communications networks. In a VVDM system, multiple channels are carried over a single optical fiber without interference between the channels, so that channel-carrying capacity is increased.

U.S. Pat. No. 6,343,166 discloses a WDM. Referring to FIG. 1, the WDM has a subassembly 610. The subassembly 610 has an outer cylindrical metal housing 612. The housing 612 surrounds an insulating cylindrical boro-silicate sleeve 614 within which there is mounted a dual capillary glass ferrule 616 receiving input and reflective optical fibers 618, 620. The ends of the optical fibers 618, 620 in the ferrule 616 face a graded index (GRIN) lens 622. The GRIN lens 622 collimates light emitting from the input optical fiber 618 into parallel rays, transmitting them to a filter 624. A holder 626 is mounted to an end 621 of the GRIN lens 622 and includes an axial aperture 627 allowing light from the GRIN lens 622 to impinge upon the filter 624 and the reflective light to be directed back to the reflective optical fiber 620. The holder 626 also receives the filter 624 in alignment with the GRIN lens 622 and has the aperture 627 extending between the filter 624 and the lens 622.

The WDM further has an outer cylindrical metal sleeve 632 into which the subassembly 610 is mounted and secured by a cylindrical interface of solder and/or welding material 631. The output signal which transmits through the filter 624 is received by an aligned GRIN lens 634 similarly secured within a boro-silicate sleeve 636 surrounded by a metal sleeve 637 which, in turn, is mounted within the outer sleeve 632 utilizing a cylindrical solder interface 633. An output optical fiber 638 mounted in a second ferrule (not labeled) couples the desired wavelength output signal from the filter 624.

However, the GRIN lenses 622, 634 are conventionally made by ion exchange method, which is expensive and problematic and must be further polished after initial formation. Furthermore, chemicals used in the ion exchange method are harmful to users and pollute the environment. A copending application with an unknown serial number filed on Jun. 5, 2002, titled “OPTICAL COLLIMATOR WITH MOLDING LENS”, and another copending application with an unknown serial number filed on Jun. 11, 2002, titled “OPTICAL ASSEMBLY”, with common applicants and the same assignee, disclose some approaches.

Therefore, it is desired to provide a WDM that has a low manufacturing cost and is environmentally friendly

### SUMMARY OF THE INVENTION

Accordingly, an object of the present invention is to provide an inexpensive WDM having good optical performance.

Another object of the present invention is to provide a WDM that is environmentally friendly:

To achieve the above-mentioned objects, a WDM in accordance with the present invention comprises a first collimator, a second collimator, a filter, a holder and an outer sleeve. The first collimator has a first ferrule within which input and reflective optical fibers are secured. The first ferrule has an oblique face at its forward end that opposes an oblique face at a rearward end of a first molded lens. The first molded lens is made using molding method. The first ferrule and molded lens are adhered together by epoxy resin. A first inner tube partially encloses the first ferrule, and a first outer tube encloses the first inner tube. The holder has a seat receiving the first molded lens therein. The filter is fixed onto a free end of the holder. The second collimator has a configuration similar to that of the first collimator, expert that the second ferrule only retains a single output optical fiber therein. The two collimators are aligned with each other and retained in the outer sleeve by welding.

Other objects, advantages and novel features of the invention will become more apparent from the following detailed description when taken in conjunction with the accompany drawings, in which:

### BRIEF DESCRIPTION OF THE DRAWINGS

FIG. 1 is a cross-sectional view of a conventional WDM;

FIG. 2 is a cross-sectional view of a WDM in accordance with the present invention;

FIG. 3 is a cross-sectional assembled view of a ferrule, a molded lens, a holder, a filter, an input optical fiber and a reflective optical fiber of the WDM of FIG. 2; and

FIG. 4 is a schematic view showing optical paths in the WDM of FIG. 2.

### DETAILED DESCRIPTION OF THE INVENTION

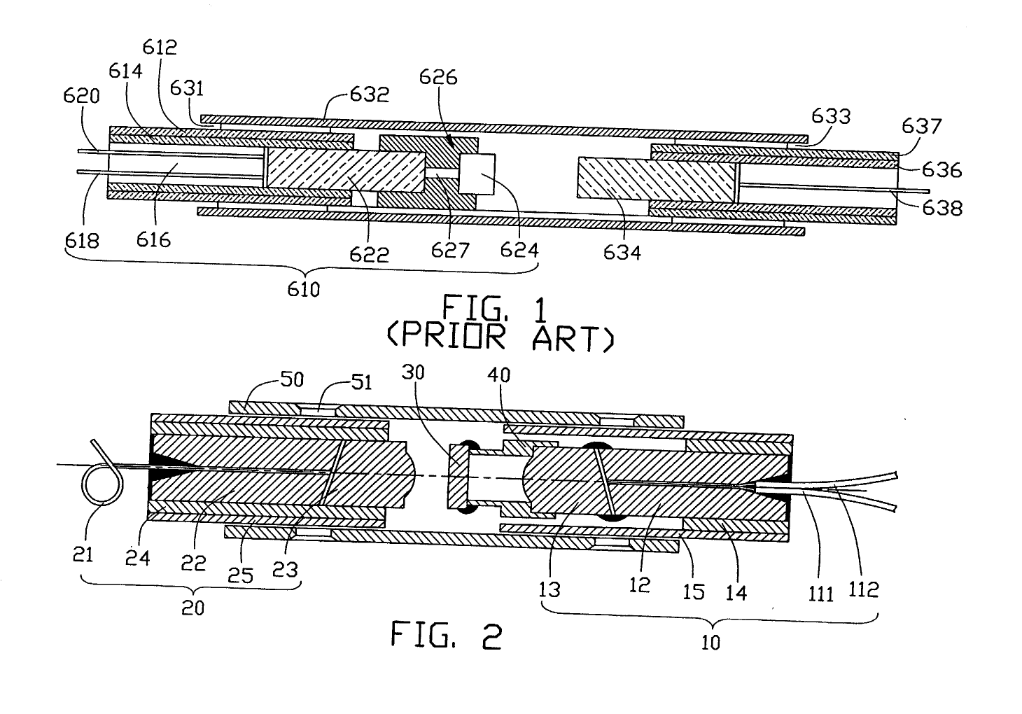

Referring to FIG. 2, a WDM in accordance with the present invention comprises a first collimator 10, a second collimator 20, a filter 30, a holder 40 and an outer sleeve 50. The holder 40 connects with the first collimator 10 and the filter 30 attaches to an end of the holder 40. The two collimators 10, 20 are aligned with each other and fastened in the outer sleeve 50 by welding.

The first collimator 10 has a first ferrule 12 within which reflective and input optical fibers 111, 112 are secured. A first molded lens 13 is joined to the first ferrule 12 by epoxy resin (not labeled). A first inner tube 14 partially encloses the first ferrule 12 therein. A combination of the first ferrule 12, the first inner tube 14, the first molded lens 13 and the optical fibers 111, 112 is then enclosed in a first outer tube 15.

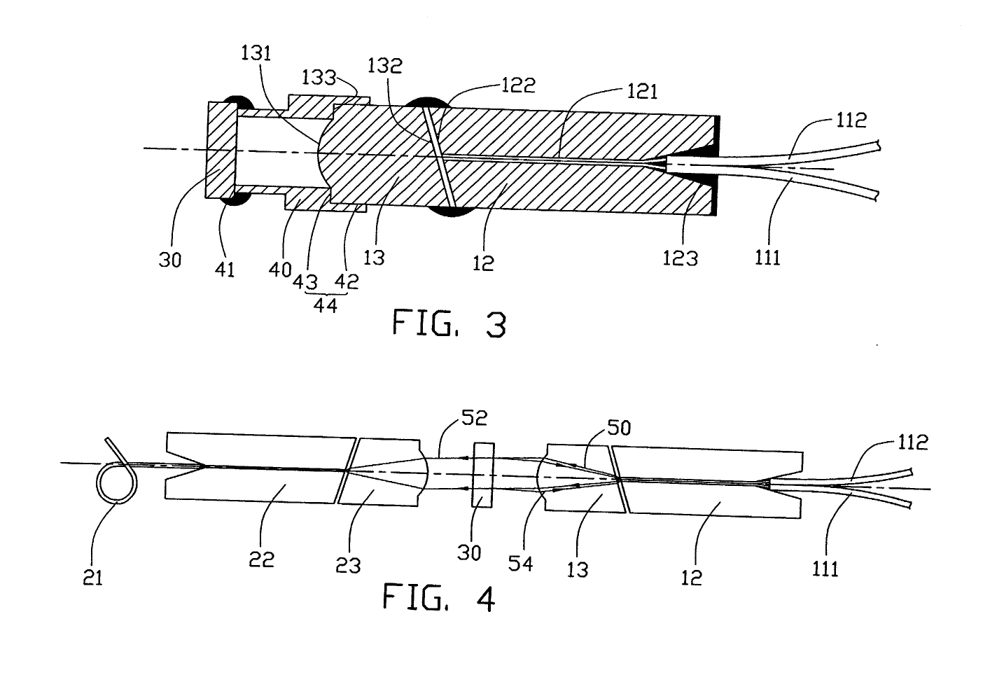

Referring to FIG. 3, the first ferrule 12 includes an oblique forward end 122 and a rearward end (not labeled) opposite to the forward end 122, a through hole 121 and an entryway 123 defined in the first ferrule 112. The entryway 123 is communicates between the through hole 121 and the rearward end (not labeled) of the first ferrule 12. The end 122 inclines at an angle preferably between 6 and 8 degrees relative to a hypothetical plane normal to a longitudinal center line of the ferrule 12.

The first molded lens 13 is made by a molding method and has an aspherical forward end face 131. A step 133 is formed around a periphery of the aspherical forward end face 131. An oblique rearward end face 132 opposite to the aspherical forward end face 131 inclines at an angle preferably between 6 and 8 degrees relative to a hypothetical plane normal to a longitudinal center line of the first molded lens 13. When assembled, the oblique rearward end face 132 is opposite to and separated by a small gap from the oblique forward end 122 of the first ferrule 12.

The holder 40 is made of a glass material, or other material that has a thermal expansion coefficient proximate to that of the filter 30. The holder 40 has an end face 41 at a front end thereof and a seat 44 at a rearward end thereof. The seat 44 comprises an inward facing retaining wall 42 which adjoins a rearward facing annular shoulder 43. When the first molded lens 13 is inserted into the seat 44 of the holder 40, the step 133 of the first molded lens 13 abuts the shoulder 43, and sides (not labeled) of the first molded lens 13 abut the retaining wall 42.

Referring back to FIG. 2, the second collimator 20 has a structure similar to that of the first collimator 10. However, a second ferrule 22 retains only an output optical fiber 21 therein. A second molded lens 23 is attached to the second ferrule 22. A combination of the second ferrule 22, the output optical fiber 21 and the second molded lens 23 is enclosed in a second inner tube 24. A second outer tube 25 then surrounds the inner tube 24.

Referring to FIG. 3, during assembly, ends of jackets of the optical fibers 111 and 112 are stripped to expose bare optical fiber cores. The bare optical fiber cores extend through the through hole 121. Jacketed end portions of the optical fibers 111, 112 are fixed in the entryway 123 by epoxy resin (not labeled). Portions of the bare optical fiber cores that protrude beyond the oblique forward end 122 of the ferrule 12 are grinded and polished to be coplanar with the oblique forward end 122.

The first molded lens 13 is attached to the first ferrule 12 by epoxy resin (not labeled), the oblique rearward end face 132 being opposite to and separated by a small gap from the oblique forward end 122 of the first ferrule 12. The first molded lens 13 is snugly inserted into the seat 44 of the holder 40, the step 133 of the first molded lens 13 abuts the shoulder 43, and sides (not labeled) of the first molded lens 13 abut the retaining wall 42. The filter 30 is then attached to the end face 41 by epoxy resin.

Referring back to FIG. 2, a combination of the first ferrule 12, the first molded lens 13, the holder 40 and the filter 30 is retained into the first inner tube 14. The first outer tube 15 retains the first inner tube 14. After that, the first collimator 10 with the holder 40 and the filter 30 is also enclosed into the outer sleeve 50. The second collimator 20 is also enclosed into the outer sleeve 50. After the first and second collimators 10, 20 are aligned with each other, welding is applied through apertures 51 to secure them in the outer sleeve 50.

Referring to FIG. 4, a focal point (not labeled) of the molded lens 13 is located at the oblique forward end 122 of the ferrule 12. Input light beams 50 emitted from the input optical fiber 112 are transmitted through the molded lens 13 in a forward direction The aspherical forward end face 131 of the molded lens 13 transmits the input light beams 50 in a forward direction as parallel light beams (not labeled). Said parallel light beams are then split by the filter 30, being transmitted in a forward direction through the filter 30 as parallel light beams 52 having a predetermined wavelength, and such parallel light beams as have other than the predetermined wavelength being reflected back to the aspherical forward end face 131 and being transmitted through he molded lens 13 as reflective light beams 54 in a rearward direction, said reflective light beams 54 are focused on an end of the reflective optical fiber 111 and are transmitted through the reflective optical fiber 111. The parallel light beams 52 are transmitted through the second molded lens 23, and are focused on an end of the output optical fiber 21 and are transmitted through the optical fiber 21.

The molded lenses 13, 23 are made by the molding method. Manufacturing period of the molding method is much shorter than that of the ion exchange method using in the GRIN lens. Furthermore, the GRIN lens is expensive and problematic, and must be further polished after initial formation. In addition, chemicals used in the ion exchange method are harmful to users and pollute the environment. Accordingly, the GRIN lens is replaced with the molded lenses 13, 23 in WDM is favored, and the WDM in accordance with the present invention has a low manufacturing cost and is environmentally friendly.

It should be understood that various changes and modifications to the presently preferred embodiments described herein will be apparent to those skilled in the art. Such changes and modifications may be made without departing from the spirit and scope of the present invention and without diminishing the present invention's advantages. Thus, it is intended that such changes and modifications be covered by the appended claims.

What is claimed is:

1. A wavelength division multiplexer for connection between an input optical fiber, a reflective optical fiber, and an output optical fiber, comprising:
a first collimator connecting to the input and reflective optical fibers and comprising a first lens, the first lens having an aspherical face being for collimating input light beams;
a holder arranged on the first lens of the first collimator;
a filter arranged onto an end face of the holder; and
a second collimator connecting to the output optical fiber and aligned with the first collimator, and comprising a second lens;
wherein when the input light beams are transmitted from the input optical fiber to the first lens in a forward direction, said light beams are collimated by the first lens and pass as parallel light beams to the filter, then such parallel light beams having a predetermined wavelength pass through the filter and are transmitted through the second lens which focuses the parallel light beams down to couple with the output optical fiber, and such parallel light beams having a wavelength other than the predetermined wavelength are reflective by the filter, pass back through the first lens in a rearward direction, and are coupled into the reflective optical fiber.

2. The wavelength division multiplexer in accordance with claim 1, wherein the first and second lenses are made by a molding method.

3. The wavelength division multiplexer in accordance with claim 1, wherein the lens of the second collimator has an aspherical face.

4. The wavelength division multiplexer in accordance with claim 2, wherein each of the lenses has an oblique end face opposite to the aspherical face, and the oblique end face inclines at an angle preferably between 6 and 8 degrees relative to a hypothetical plane normal to a longitudinal center line of the lens.

5. The wavelength division multiplexer in accordance with claim 2, wherein each of the lenses has a step, and each step is formed around a periphery of the aspherical face.

6. The wavelength division multiplexer in accordance with claim 4, wherein the first collimator comprises a first ferrule fastened to the first lens, and the first ferrule defines a through hole within which the input optical fiber and the reflective optical fiber are retained.

7. The wavelength division multiplexer in accordance with claim 6, wherein the first ferrule defines an entryway in communication with the through hole.

8. The wavelength division multiplexer in accordance with claim 6, wherein the first ferrule comprises an oblique forward end which inclines at an angle preferably between 6 and 8 degrees relative to a hypothetical plane normal to a longitudinal center line of the ferrule, and the oblique forward end is positioned opposing the oblique end face of the lens.

9. The wavelength division multiplexer in accordance with claim 1, wherein the second collimator comprise a second ferrule fixed to the second lens, and the second ferrule defines a through hole within which the output fiber is retained.

10. The wavelength division multiplexer in accordance with claim 9, wherein the second ferrule defines an entryway in communication with the through hole.

11. The wavelength division multiplexer in accordance with claim 5, wherein the holder has a seat, and the seat forms a shoulder for abutting the step of the first lens.

12. The wavelength division multiplexer in accordance with claim 1, further comprising an outer sleeve for retaining the first and second collimators therein.

13. The wavelength division multiplexer in accordance with claim 12, wherein the outer sleeve defines a plurality of apertures, and welding is applied through the apertures to secure the first and second collimators in the outer sleeve.

14. An optical assembly comprising:
a ferrule defining a through hole for retaining an optical fiber;
a lens arranged adjacent to the ferrule, the lens having an aspherical face on one end thereof; and
a holder attached to the lens at the end of the lens having the aspherical face; and
a filter attached onto the holder.

15. The optical assembly in accordance with claim 14, wherein the lens has a step, and the step is formed around a periphery of the aspherical face.

16. The optical assembly in accordance with claim 15, wherein the holder has a seat, the seat forms a shoulder for abutting the step of the lens.

17. An optical assembly comprising:
a ferrule with at least one fiber therein;
a lens secured to one end of said ferrule, said lens defining an aspherical face thereon opposite to said ferrule; and
a holder defining a through hole with two opposite ends thereof; wherein at least one end of said lens is retained to one of said two opposite ends of the holder, and a filter is retained to the other of said two opposite ends of the holder with a space defined between said filter and said aspherical face.

18. The assembly in accordance with claim 17, wherein said aspherical face extends into the through hole axially.

19. The assembly in accordance with claim 17, wherein said through hole is dimensioned diametrically beyond one half of an outer contour thereof
